(19) United States
(12) Patent Application Publication
(10) Pub. No.: US 2007/0002131 A1
(43) Pub. Date: Jan. 4, 2007

(54) Dynamic interactive region-of-interest panoramic/three-dimensional immersive communication system and method

(76) Inventor: Kurtis J. Ritchey, Leavenworth, KS (US)

Correspondence Address: CARDINAL LAW GROUP, Suite 2000, 1603 Orrington Avenue, Evanston, IL, 60201, US

(21) Appl. No.: 11/354,779

(22) Filed: Feb. 15, 2006

Related U.S. Application Data
(60) Provisional application No. 60/652,950, filed on Feb. 15, 2005.

(51) Int. Cl. H04N 7/00

(52) U.S. Cl. 348/39; 348/36

(57) ABSTRACT

A method of dynamic interactive region-of-interest panoramic immersive communication involves a capturing a panoramic image and a specification of a size and a location of a region-of-interest in the panoramic image.

### RELATED APPLICATION DATA

This application claims the benefit of U.S. Provisional Application Ser. No. 60/652,950 filed on Feb. 15, 2005.

### FIELD OF THE INVENTION

In the same vain this invention has as its objective and aim to converge new yet uncombined technologies into a novel, more natural and user-friendly system for communication, popularly referred to today as “telepresence”, “visuality”, “videoality”, or “Image Based Virtual Reality” (IBVR).

### BACKGROUND OF THE INVENTION

What the present invention teaches and is novel is integration of either “an event-driven random-access-windowing CCD-based camera” and tracking system developed by Steve P. Monacos, Raymond K. Lam, Angel A Portillo, Gerardo G. Ortiz; Jet Propulsion Laboratory, California Institute of Technology, taught in “smspie04.pdf” or/and the integration of “Large format variable spatial acuity superpixel imaging: visible and infrared systems applications” (ref. 11c above). by Paul L. McCarley, UAFRL, and Mark A. Massie and J. P. Curzan Nova Biomimetics with spherical panoramic camera and communications systems disclosed by Ritchey in parent patents and the provisional application, Case No. 4100/5 filed by Cardinal Law Group on 19 May 2004 titled “Improved Panoramic Image-Based Virtual Reality/Telepresence Audio-Visual System and Method.” By incorporating the JPL and Nova camera and tracking systems specific ROI areas in the spherical scene are isolated for transmission and viewing, thus reducing bandwidth of the image or images that need to be processed and communicated. Further advantages as they are described below in the sections on the object of the invention and detailed descriptions that form a basis for the claims.

### OBJECT OF THE INVENTION

The primary objective of the invention is to provide a more efficient input means for providing panoramic video for personal telepresence communication and interactive virtual reality. While it is beneficial in some instances to simultaneously record a complete scene about a point, it is not desirable in all instances. For example, the original Ritchey 1989, then McCuthen 1992, and later iMove 1999 spherical panoramic cameras use a plurality of cameras faced outward from a center point to simultaneously record an entire panoramic scene. A limitation of using a plurality of cameras is the requirement to simultaneously transmit, process, and store a large amount of information. And in these instances a limitation is the cost of buying multiple camera systems. Additionally, a limitation is that multiple cameras increase the weight and size of the panoramic camera system. Additionally, a limitation is there are more components that can break. Additionally, a limitation is plural cameras must be placed adjacent to one another pushing the actual objective taking lenses of each camera outward from a center point which causes adjacent subject stitching problems due to each lenses widely different points-of-view. While impossible, ideally the point of view for all panoramic objective lenses facing outward would be a single point in space. Advantages of using a plurality of cameras is that panoramic scenes had higher resolution because many imaging devices recorded each adjacent or overlapping segment that make up the composite panoramic scene.

On the other hand, the spherical panoramic camera by Ritchey in 1992 was the first to simultaneously record a complete spherically panoramic scene on the recording surface of a single conventional rectangular shaped imaging device. The advantage of this was that only one camera was necessary, which lowered cost, device maintenance, weight, processing efficiency, and improved compactness. The limitation however, was that resolution was typically limited because an entire spherical scene was imaged on a single imaging device, which had limited resolution. When an entire panoramic scene was placed on the device only a small portion of the scene was devoted to any one place on the imaging device. So that when the scene was enlarged the resulting resolution was often low and pixilated. Of course the solution was to use a higher resolution sensor or film. But these alternatives also had limitations, like high sensor costs and developing and production costs.

A limitation of both panoramic camera systems using single high-resolution camera or a plurality of cameras was that a reading out the signal or signals from the systems took up a very large bandwidth. Reading this bandwidth from the panoramic camera system and processing the output has been a limitation of theses systems. The present invention overcomes these limitations.

In the years since those devices were built, higher resolution sensor costs have decreased. Additionally, image-processing capabilities have improved. Application requirements have changed also. For instance, in most live personal telepresence applications only the portion of the panoramic scene the user wants to view needs be recorded, processed, and communicated at any one time, not the entire scene as was done in some of the examples discussed above. Switching and multiplexing systems have been used to accomplish this when using a plurality of cameras, but the above-mentioned limitations of using a plurality of cameras remained. Alternatively, devices to sample out or select an image segment, also referred to as a “Region of Interest” (ROI) from a single camera sensor have not existed until recently. And until the present invention sampling out a plural number of ROI, or “Regions-of-Interest (ROIs) from a single frame had not been used in connection with fisheye lenses to provide imagery for building or panning a spherical field-of-view scene. Recent and developing printed circuit board and micro-chip technology allow for both imaging and associated processing of the image to be accomplished in a compact manner.

A problem with earlier panoramic camera systems has been reduction and removal of barrel distortion caused by wide-angle lenses. As mentioned earlier, one solution was simply use a plurality of lenses with very little distortion. The problem with this was that a great deal of computer processing to stitch the images together was required. So very wide-angle and fisheye lenses have been used, which bring us back to solving a distortion problem. The present invention offers both an optical arrange and hardware/software or firmware arrangement for solving the distortion problem.

In the present invention a specially designed fiber optic imaging assembly to reduce or remove wide-angle objective lens distortion of an image(s) taken by the spherical field-of-view camera used with ROI processing has not been described until the present invention. This embodiment is advantageous because it provides an image derived from a panoramic camera that is better suited for ROI processing. The combination of these devices facilitates a more efficient system for applications such as telepresence and immersive gaming.

Alternatively, another method of reducing or removing wide-angle objective lens distortion of an image(s) is by the use of software or firmware. The software or firmware is included as part of the processing means. The processing means operates on the information included in tables and/or algorithms which are applied to the ROI image(s) in order to remove the image distortion. Unlike previous systems in which the entire image panoramic scene was transmitted to the processor and then the image segment to be viewed was selected and read-out, in the present system only the image segment(s), ROI's, to be viewed is/are read-out from the camera and associated conjunctive camera processing means. Thus processing is determined prior to read out from the camera and prior to transmission. And preferably, the image segment may also be operated upon to remove distortion and to stitch the image together for viewing prior to transmission to a remote location. This method of image manipulation is advantageous because it dramatically reduces bandwidth transmission requirements for transmitting panoramic imagery to remote communication.

### DRAWINGS OF THE PRESENT INVENTION

FIG. 1 illustrates the generational evolution of telephone communication, and summarizes the benefits to the current invention over previous telephone systems.

FIG. 2. is a schematic drawing illustrate a first embodiment of the components, interaction of the components, and resulting product of the interaction between components of the invention that incorporate Region of Interest image processing.

FIG. 3. is a schematic drawing illustrate a second embodiment of the components, interaction of the components, and resulting product of the interaction between components of the invention that incorporate Region of Interest image processing.

### SPECIFICATION/DETAILED DESCRIPTION OF THE PRESENT INVENTION

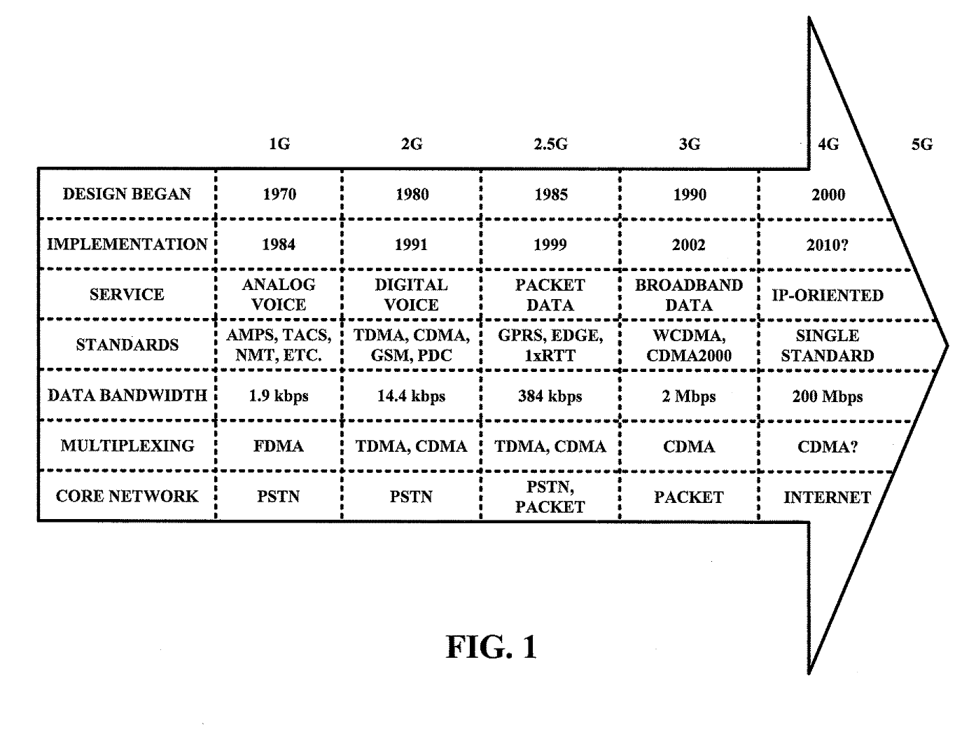

FIG. 1 illustrates the evolution of Generation One through Generation Four Wireless Telephone technology, popularly referred to in the current telephone industry as G1-G4 wireless telephone technologies. Generation one, referred to as G1 in the telecommunications industry, was the first wireless telephone implemented in 1984. Generation 2 wireless phone telephone technology was implemented in 1991. Generation 2.5 offered consumers significant improvements came in 1999. Generation 3 wireless phone technology, which we are currently entering was implemented in 2002.

The following chart by Jawad Ibrahim provides a good history of telecommunications technologies as invisioned up to the present time: (Include chart here or update as FIG. 1, see ref 15).

The objective of the present and related parent inventions are enabled by Generation 4 wireless telephone capabilities. The present invention enabled by G4 capabilities is heretofore put forth and referred to as a G4.5 telecommunications capability. Generation 4.5 is Telepresence or Image Based Virtual Reality cellular telecommunications. The present inventor envisions teleportation as what will be considered Generation 5 telecommunication technologies.

While the present invention by inference teaches one skilled in the art that the system disiclosed here may be incorporated in a larger non-mobile embodiment. The preferred embodiment is a wireless, mobile, cellular embodiment, worn by a user. The larger less portable embodiment of the system requires less miniaturized hardware, is less expensive, and uses off-the-shelf hardware disclosed in the existing JPL and Nova. This invention discloses how that existing technology can be incorporated with a panoramic camera to achieve telepresence. The larger system is suitable for conventional viewing on a monitor, video teleconferencing system, immersive room, or use with other similar display systems. However, the preferred example detailed in the specification specifically discloses how miniturized ROI systems disclosed by Nova and JPL can be incorporated with wearable or handheld cellular systems and immersive display and audio telecommunication systems to achieve mobile personal immersive telepresence.

It is known in the camera industry that camera-processing operations may be placed directly onto or adjacent to the image-sensing surface of the CCD or CMOS chip to save space and promote design efficiency. For example, the Dalsa 2M30-SA, manufactured by Dalsa, Inc., Waterloo, Ontario, Canada, has a 2048×2048 pixel resolution and color capability incorporates Region Of Interest (ROI) processing on the image sensing chip. In the present invention this allows users to read out the image area of interest the user is interested in and specifies instead of the entire 2K by 2K image. Here-to-fore all images comprising the entire panoramic scene, whether from a single or plural cameras were read out to the processor, then the ROI was sampled out for display. In the present example only the ROI or ROIs are sampled and processed for display, eliminating the need for processing a great deal of unnecessary information. Additionally, the entire panoramic scene or large regions of interests are binned at lower resolution to reduce the amount of information necessary for transmission and processing. (Ref. Application entitled: IMPROVED PANORAMIC IMAGE-BASED VIRTUAL REALITY/A TELEPRESENCE AUDIO-VISUAL SYSTEM AND METHOD”; Inventor: Kurtis J. Ritchey; Legal Representative: Cardinal Law Group; Case #: 4100/5 filed on 19 May 04; pages 26-27.)

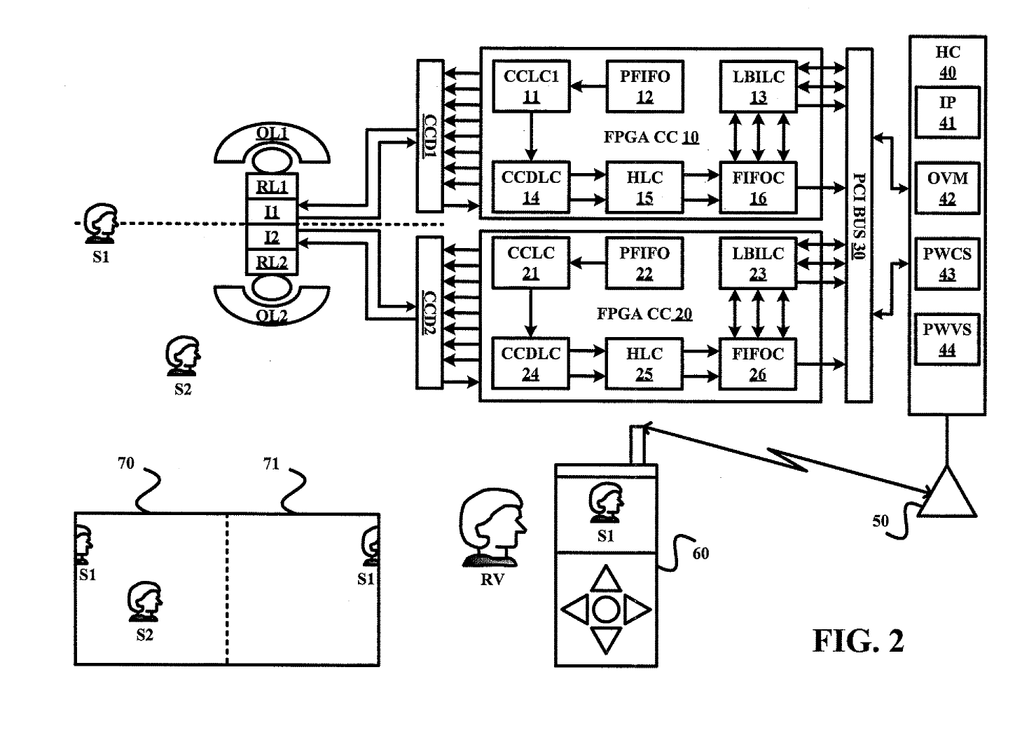

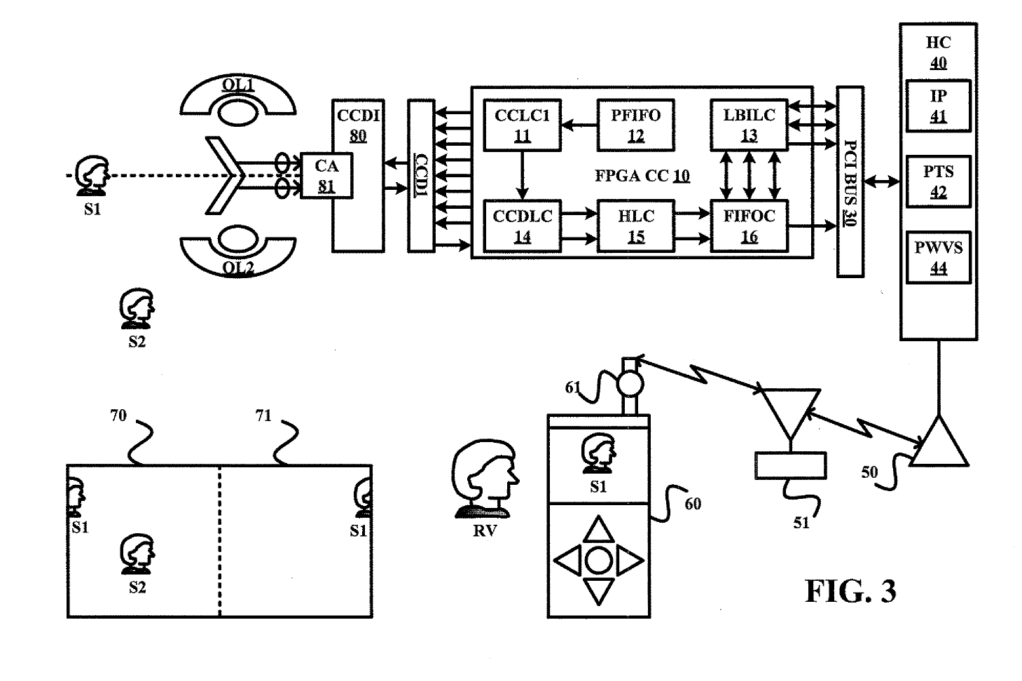

FIG. 2 and FIG. 3 are schematic drawing illustrating the components, interaction of the components, and resulting product of the interaction between components of the invention that incorporate Region of Interest (ROI) image processing.

In a first embodiment of the ROI system shown in FIG. 2, two 2K×2K sensors are placed back-to-back (like in FIG. 23 of the parent invention) and the region or regions of interest are dynamically and selectively addressed depending on the view defined by the users interactive control device. The sensors are addressable using software or firmware associated with the computer-processing portion of the system. The computer-processing portion of the system can be located in a housing worn by a user or in a device carried by a user for wireless applications. Still further, the computer processing means incorporate processing means of a host desktop or laptop. For instance the computer processing can be designed into a personal digital assistant (PDA) or a personal cellular phone (PCS) device (120). In order to save space the computer-processing portion of the system can comprise a Very Large Scale Integrated Circuit (VLSIC).

In FIG. 2 each objective lens group reflects a portion of the surrounding scene to the imager and signal processing circuitry. Arrows and lines are used to show the signal readout of the sampled imagery that is sent from the CCD imager and signal processing circuitry. Each FPGA Controller Card is operated such that only designated ROI and ROI's imagery is transmitted to the host computer. The host computer transmits commands to each FPGA Controller Card to define the scene the user wants to view on his or her display. The host computer does this by incorporating position sensing/feature tracking software or firmware well known in the security industry.

For instance, say the Remote Viewer (Mr. Green Smilie Face), wants to only watch only Miss Yellow Smilie Face at a remote location. Mr. Green operates his blue Panoramic/3-D Capable Wireless Cellular Phone to select Ms Yellow for tracking. One method of doing this is by Mr. Green operating the Interactive Control Devices to use the arrow keys to put a cursor on Ms. Yellow and clicking the red control button to enter his selection. To help facilitate this input Mr. Green can display the entire panoramic scene, as illustrated in the recorded panoramic picture frame shown in the lower left-hand corner of FIG. 2. The computer on the cellular phone records identifying features of Ms. Yellow and begins tracking her as long as she is in the field of view of the panoramic camera. While Ms. Yellow is being tracked her image is being transmitted to Mr. Green. In this manner he can carry on a personal face-to-face conversation with Ms. Yellow even as she moves around the environment at another location.

Once Ms. Yellow's features are recorded, the host computer can operate on those stored features to automatically find, track, and transmit Ms. Yellow's image to Mr. Green. Assuming she is in the imaged environment and Mr. Green has asked for her to be found.

Each image sensor will record images in a corresponding portion of the surrounding environment. Coordinates input by the user operating interactive input controls of the system define the scene or subject to be tracked. These inputs define the ROI or ROIs, which the host computer samples out, processes for display, and transmits to the viewer. In embodiment one, two sensors are used. Because two sensors are used there will be instances where a portion of the subject will record by one image sensor, and another will be located in the other image sensor. In the present example, half of Ms Yellow, also referred to as subject #1 sub a, is in recorded image side #1, and half of subject #1 sub b, is recorded image side #2. When the subject is recorded by multiple sensors the image is matched up and stitched together prior to display. Matching, stitching, and distortion removal of the scene together prior to display is well know to those in the panoramic video industry. (Examples of this can be read in the iMove Patent ______ and ipix Patent ______ incorporated herein by reference). As illustrated in the lower left of FIG. 2, when the entire subject is located in whole on the Recorded Panoramic Picture Frame, as with Ms Pink smilie face, also called Subject #2 no matching and stitching is required.

Additionally, in the “Recorded Panoramic Picture Frame 360×360 degree Field-of-View Coverage”, the barrel distortion of the image caused by the fisheye lenses have been removed. The image distortion is removed by look-up tables and/or algorithms that is part of the processing means of the panoramic communication device 120 or 122. Besides being located in the host computer, processing means to remove distortion can be included in firmware embedded on Very Large Scale Integrated Circuit (VLSIC) that are associated with and in communicating relationship with the image sensors, feature tracking, and the image display and transmission means of the communications device 120 or 122.

Alternatively, FIG. 3 shows a second embodiment of the ROI system, wherein one 2K×2K imager is incorporated and off axis optical image relay means such as fiber optic image conduits, mirrors, or prisms are used to transmit images to a single CCD with ROI or plural ROI capabilities.

Instead of a plurality or multiplicity of ROI sensors like in FIG. 2, a single ROI sensor is incorporated in FIG. 2. In FIG. 3 a single charge-coupled-device (CCD) based high-speed imaging system, called a real-time, event-driven (RARE) camera, is illustrated. This camera is capable of readout from multiple sub-windows [also known as regions of interest (ROIs)] within the CCD field of view. Both the sizes and the locations of the ROIs can be controlled in real time and can be changed at the camera frame rate. The predecessor of this camera was described in “High-Frame-Rate CCD Camera Having Subwindow Capability” (NPO-30564) NASA Tech Briefs, Vol. 26, No. 12 (December 2002), page 26. The architecture of the prior camera requires tight coupling between camera control logic and an external host computer that provides commands for camera operation and processes pixels from the camera. This tight coupling limits the attainable frame rate and functionality of the camera.

The design of the present camera loosens this coupling to increase the achievable frame rate and functionality. From a host computer perspective, the readout operation in the prior camera was defined on a per-line basis; in this camera, it is defined on a per-ROI basis. In addition, the camera includes internal timing circuitry. This combination of features enables real-time, event-driven operation for adaptive control of the camera. Hence, this camera is well suited for applications requiring autonomous control of multiple ROIs to track multiple targets moving throughout the CCD field of view. Additionally, by eliminating the need for control intervention by the host computer during the pixel readout, the present design reduces ROI-readout times to attain higher frame rates.

In FIG. 2 and FIG. 3 the camera system includes an imager card(s), respectively, consisting of a commercial CCD imager and two signal-processor chips. The imager card converts transistor/transistor-logic (TTL)-level signals from a field programmable gate array (FPGA) controller card. These signals are transmitted to the imager card via a low-voltage differential signaling (LVDS) cable assembly. The FPGA controller card is connected to the host computer via a standard peripheral component interface (PCI). The host computer sends control parameters to the FPGA controller card and reads camera-status and pixel data from the FPGA controller card. Some of the operational parameters of the camera are programmable in hardware. Commands are loaded from the host computer into the FPGA controller card to define such parameters as the frame rate, integration time, and the size and location of an ROI.

There are two modes of operation: image capture and ROI readout. In image-capture mode, whole frames of pixels are repeatedly transferred from the image area to the storage area of the CCD, with timing defined by the frame rate and integration time registers loaded into the FPGA controller card. In ROI readout, the host computer sends commands to the FPGA controller specifying the size and location of an ROI in addition to the frame rate and integration time. The commands result in scrolling through unwanted lines and through unwanted pixels on lines until pixels in the ROI are reached. The host computer can adjust the sizes and locations of the ROIs within a frame period for dynamic control to changes in the image (e.g., for tracking targets).

I claim:

1. A method of dynamic interactive region-of-interest panoramic immersive communication, the method comprising:
capturing a panoramic image; and
specifying a size and a location of a region-of-interest in the panoramic image.

2. A device for a dynamic interactive region-of-interest panoramic immersive communication, the device comprising:
means for capturing a panoramic image; and
means for specifying a size and a location of a region-of-interest in the panoramic image.
